(19) United States
(12) Patent Application Publication
(10) Pub. No.: US 2009/0067524 A1
(43) Pub. Date: Mar. 12, 2009

(54) GUARD INTERVAL LENGHT SELECTION IN AN OFDM SYSTEMS BASED ON COHERENCE BANDWIDTH OF THE CHANNEL

(75) Inventor: Pen Li, San Jose, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/281,422

(22) PCT Filed: Feb. 24, 2007
(86) PCT No.: PCT/IB07/50595

§ 371 Date: Sep. 20, 2008

Related U.S. Application Data
(60) Provisional application No. 60/778,515, filed on Mar. 1, 2006.

(51) Int. Cl. H04L 27/28

(52) U.S. Cl. 375/260

(57) ABSTRACT

A system, apparatus and methods are described that identify a maximum cyclic delay and corresponding cyclic prefix for a multi-path communications channel. In one embodiment, the maximum cyclic delay (245) is identified based on a relationship between a selected covariance bandwidth (235) and RMS delay (240) of the OFDM channel.

The present invention relates generally to wireless communication technology, and more particularly, to the determination of an appropriate cyclic delay introduced at an OFDM symbol based on frequency correlation characteristics within a wireless channel.

The importance of wireless communication and its application to numerous different markets is well understood. Wireless technology and devices are continually being improved to include new features and functionality that enables a user to communicate, both voice and data, more effectively. One such feature, WLAN communication, is being integrated into a number of different wireless devices including cellular phones, smart phones and personal data assistants (“PDAs”).

Wireless devices may communicate with each other in both a point-to-point connection or on a networked connection, such as a wireless local area network (“WLAN”). A WLAN access point operates as a gateway on a network and allows the wireless device to communicate with other devices on the network. This communication oftentimes requires that the communication channel between the devices conform to a particular standard of communication, such as the IEEE 802.11 standards. In order to establish a communication channel, the wireless device and/or access point analyze the channel in order to define certain communication characteristics.

This communication channel may employ orthogonal frequency division multiplexing (“OFDM”) which transmits data over a number of different carriers within the channel. OFDM systems are characterized as having high spectral efficiency and good resiliency to RF interference. OFDM channels are multi-path resulting in signal distortions which may be caused by a number of factors including spatial variations in temperature, pressure, humidity, etc. that cause variations in the index of reflection as well as the reflection of signals off of various objects. Because OFDM channels are multi-path, groups of frequencies may be attenuated and shifted in phase within the frequency domain, and adjacent symbols may smear into each other in the time domain.

An OFDM channel delay spread may also adversely affect the channel's performance. For example, if the channel delay spread is relatively short, then the OFDM channel may be flat (i.e. the signal is faded equally) resulting in longer error bursts. This bursty nature of the signal is oftentimes difficult to correct at the receiver and may significantly reduce the channel performance. In order to lengthen the channel delay spread, the OFDM channel frequency diversity may be increased to reduce the error bursts within the signal. One manner in which the channel delay spread may be lengthened is by introducing cyclic delays or prefixes to OFDM symbols within the channel.

The calculation of appropriate cyclic delay lengths may require a significant number of calculations at an OFDM transmitter. Depending on the communication system, and transmitters therein, these calculations may adversely affect the performance of the communication system and overburden the transmitters.

A system, device and method for selecting a maximum cyclic delay length for an OFDM system are described. One embodiment of the invention provides an efficient manner of selecting a cyclic prefix below a maximum cyclic delay length for an OFDM channel by performing a number of the operations within the frequency domain. The maximum cyclic delay length is identified by using a relationship between a signal's coherence bandwidth and RMS delay.

A wireless device receiving an OFDM signal typically transforms the signal into the frequency domain. One method in which the transformation may be performed is by applying a Discrete Fourier Transform to the signal.

A coherence bandwidth is determined for the wireless channel using the OFDM signal. In one embodiment, the coherence bandwidth may be determined using frequency correlation characteristics of the OFDM signal. A RMS delay is then estimated using the determined coherence bandwidth according to an inversely proportional relationship between the RMS delay and the coherence bandwidth. This estimation effectively maps the metrics from the frequency domain into the time domain, where the metric of cyclic delay resides. A scaling factor may be applied in the estimation process that depends on the determined coherence bandwidth of the signal.

A maximum cyclic delay may be approximated according to an inversely proportional relationship with RMS delay. A cyclic prefix having a corresponding length equal to or less than the maximum cyclic delay is introduced into an OFDM symbol or constellation prior to transmission onto the OFDM channel.

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. (“FIG.”) 1 is an illustration of a WLAN including an access point with which a wireless device may communicate according to one embodiment of the invention.

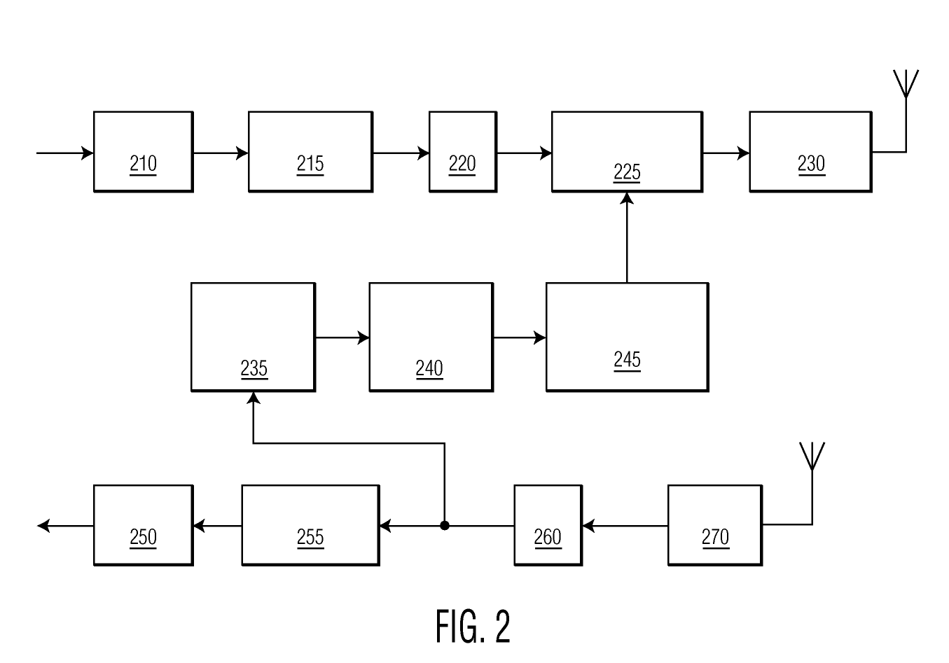

FIG. 2 is a block diagram of transmitter and receiver data paths according to one embodiment of the invention.

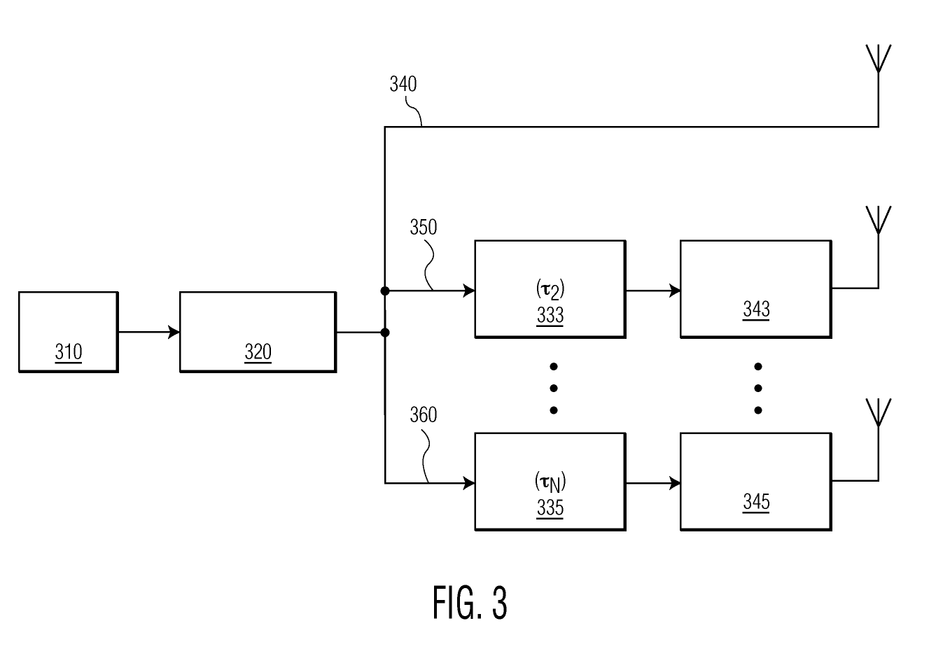

FIG. 3 is a diagram of cyclic prefix insertion within a transmitter according to one embodiment of the invention.

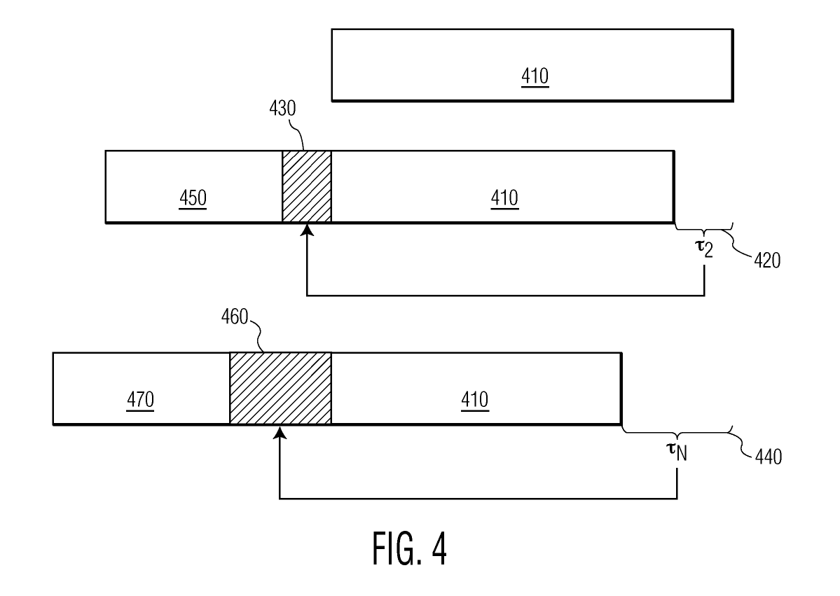

FIG. 4 is a block diagram of cyclic delay on an OFDM symbol(s) according to one embodiment of the invention.

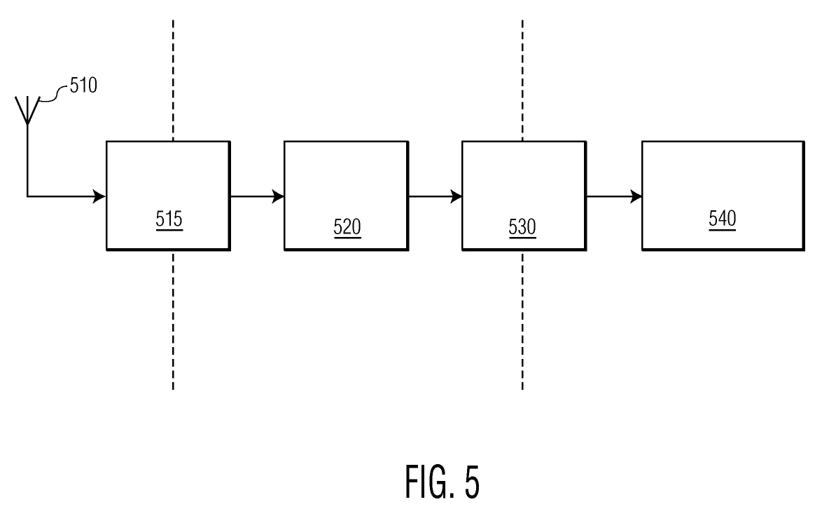

FIG. 5 is a block diagram of an apparatus that selects a maximum cyclic delay length according to one embodiment of the invention.

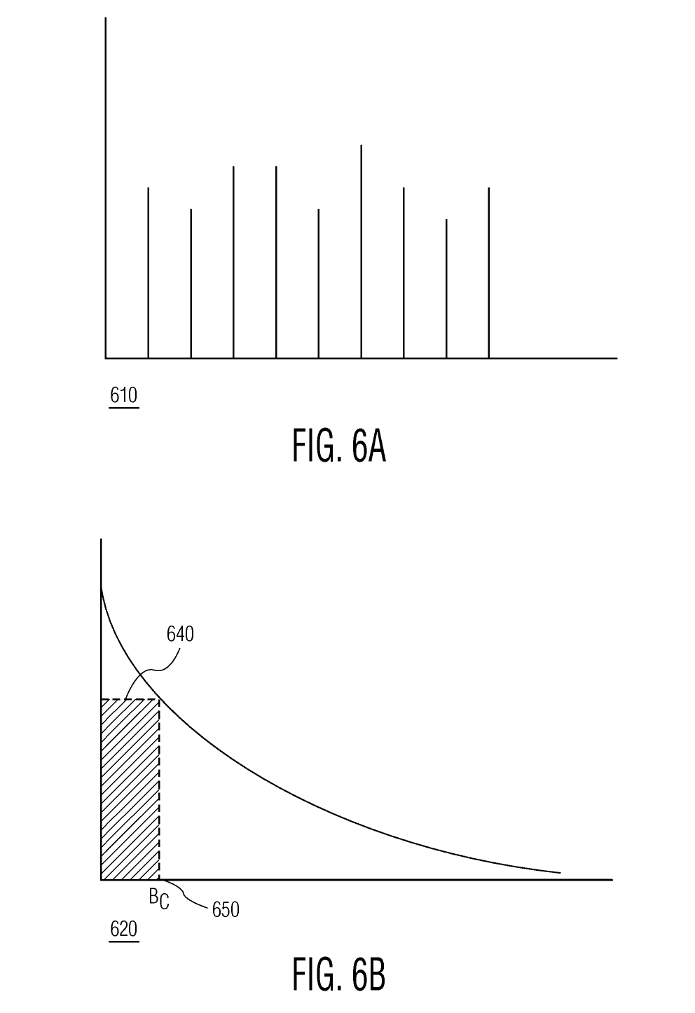

FIG. 6A is an exemplary plot illustrating carrier frequencies within an OFDM channel according to one embodiment of the invention.

FIG. 6B is an exemplary frequency covariance function chart for the OFDM channel according to one embodiment of the invention.

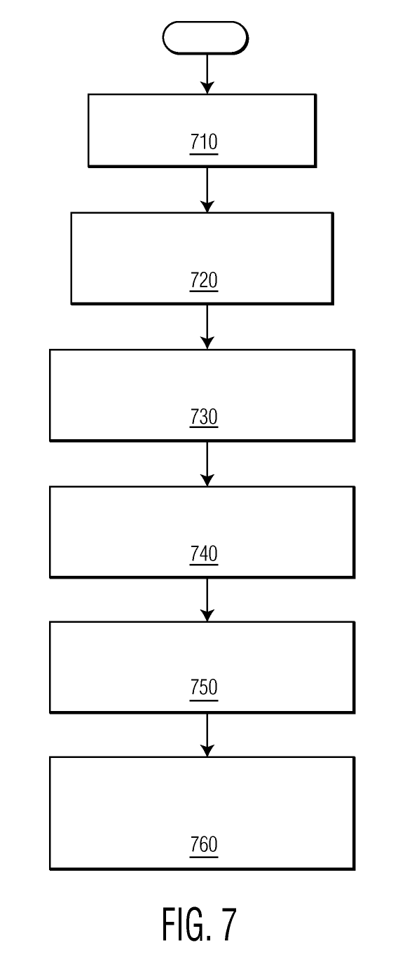

FIG. 7 is a flowchart illustrating a method for determining a cyclic delay according to one embodiment of the invention.

A system, apparatus and method is described for identifying a maximum cyclic prefix length that may be introduced to symbol within an OFDM signal. In one embodiment of the invention, a received OFDM signal is converted into the frequency domain and a corresponding frequency covariance function is calculated for the carriers within the signal. Using the frequency covariance function, a frequency correlation for the signal carriers is identified and a coherence bandwidth is determined by applying a first threshold value to the signal's frequency correlation.

A root mean square (“RMS”) delay, within the time domain, may be estimated for the wireless channel using the previously determined coherence bandwidth according to an inversely proportional statistical relationship between coherence bandwidth and RMS delay. Using the RMS delay, a maximum cyclic delay is approximated for an OFDM symbol according to an inversely proportional relationship with the RMS delay. A cyclic prefix of a length equal to or less than the maximum cyclic delay is selected and introduced at an OFDM symbol.

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be incorporated in a number of different wireless devices including wireless access points, wireless routers, cellular phones, smart phones and PDAs. The present invention may be integrated within these wireless devices as hardware, software or firmware. Accordingly, structures and devices shown below in block diagram are illustrative of specific embodiments of the invention and are meant to avoid obscuring the invention. Furthermore, connections between components and/or modules within the figures are not intended to be limited to direct connections. Rather, data between these components and modules may be modified, re-formatted or otherwise changed by intermediary components and modules.

Reference in the specification to “one embodiment”, “another embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. System Overview

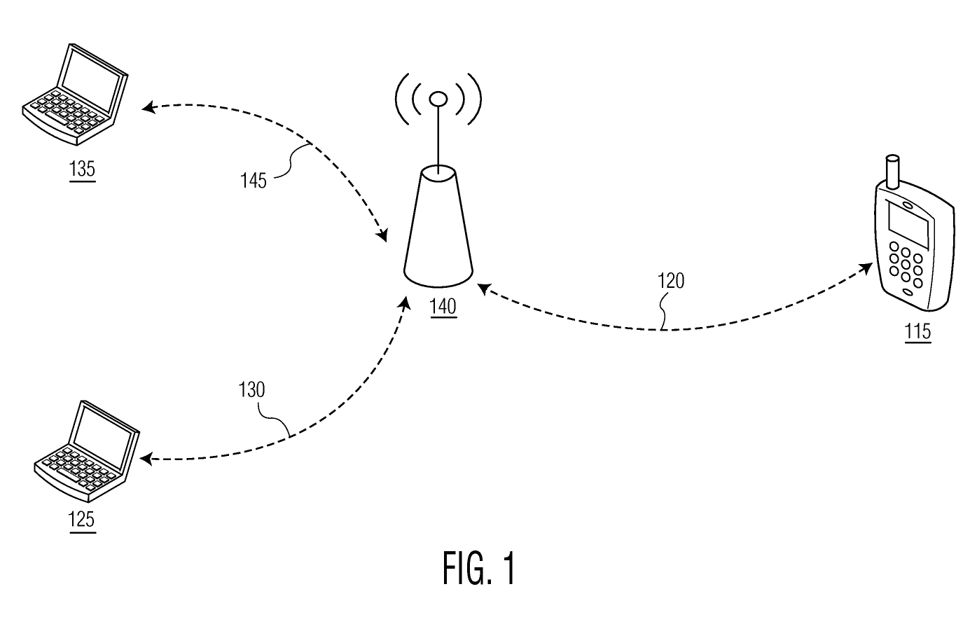

FIG. 1 illustrates a WLAN, having an access point, in which a plurality of wireless devices may communicate. The WLAN includes a wireless access point 140, a plurality of network stations which may include computers 125, 135 and a mobile wireless device 115 such as a cellular telephone. The wireless access point 140 may include a network switch or router.

The wireless access point 140 and other devices 115, 125, 135 communicate with each other using wireless multi-path channels 120, 130, 145, such as OFDM channels. An OFDM channel is a multi-carrier channel in which data is transmitted on multiple frequencies. The formats of these channels 120, 130, 145 may be adjusted according to the environment and channel characteristics in which the communication is to occur. For example, a certain communication channel may have a large amount of inter symbol interference caused by multi-path reflection. In such a scenario, the devices communicating on this channel would need to address this multi-path distortion caused by this reflection. Additionally, the type of communication, such as voice or data, on the channel may have different characteristics that need to be addressed.

It is important that the channels 120, 130, 145 keep sufficient frequency selectivity within each of the channels by maintaining appropriately delay spreads. These delay spreads prevent long error bursts and maintain enough diversity within the channel to operate properly. One method that may be used to maintain sufficiently large delay spreads in by introducing cyclic delay within the symbols being transmitted within the channels 120, 130, 145. This cyclic delay may be optimized to provide a preferred OFDM signal at a receiver.

FIG. 2 illustrates an OFDM system in which a cyclic prefix is selected and inserted into a signal according to one embodiment of the invention. A receiver 270 receives an OFDM signal and an FFT module 260 converts the signal into the frequency domain. Thereafter, the frequency domain signal is demodulated by a demodulator 255 and decoded by a decoder 250. Other devices and components may also be included within the receiver data path.

A frequency covariance module 235 receives a frequency domain signal from the receiver data path. In one embodiment, the frequency covariance module 235 receives the frequency domain signal after the FFT module 260 and prior to demodulation. The frequency covariance module 235 identifies a frequency correlation within the signal using a covariance function. This correlation is subsequently used to derive a coherence bandwidth for the signal. An RMS delay calculation module 240 estimates an RMS delay associated with the derived coherence bandwidth. Thereafter, a maximum cyclic prefix is identified by the cyclic prefix length selector 245 using the estimated RMS delay of the signal. This identification of a maximum cyclic prefix length is described in more detail below.

A transmit data path is illustrated in which an encoder 210 encodes data symbols within the frequency domain and a modulator 215 modulates the data onto a signal. An IFFT module 220 converts the modulated frequency domain signal into the time domain. A cyclic prefix module 225 provides a cyclic prefix for a symbol prior to transmission. The cyclic prefix module 225 interfaces with the cyclic prefix length selector 245 to identify the maximum length of cyclic prefix that may be inserted. In various embodiments of the invention, the cyclic prefix module 225 may provide different cyclic delay lengths or prefixes depending on the characteristics of the OFDM channel or a particular standard. Thereafter, a transmitter 330 transmits the OFDM signal to a corresponding receiver.

FIG. 3 illustrates an exemplary transmitter in which a cyclic delay or prefix is introduced into symbols prior to transmission. As illustrated, a symbol mapper 310 maps data into symbols within a signal for transmission. In one embodiment of the invention, this mapping occurs within the frequency domain. The symbols are then converted into the time domain by an Inverse Fourier Transform module 320 so that they may be transmitted onto the OFDM channel.

Multiple antennas are used to transmit the symbols onto the OFDM channel. A cyclic delay (τ_{N}) is identified and spread across the multiple antennas. In this particular embodiment, N antennas are used to transmit a symbol. A first path 340 does not introduce a cyclic delay into a symbol on an OFDM carrier signal. A second path 350 introduces a first cyclic delay τ₂ 333 associated with a cyclic prefix 343 to the symbol on a second OFDM carrier signal. An nth path 360 introduces a nth cyclic delay θ_{N} 335 and a cyclic prefix 345 to the symbol on an nth OFDM carrier signal. In one embodiment of the invention, the cyclic delays progressively increase across the antenna array. For example, if there are three antennas within the array τ₂=τ_{N}/2 and τ₃=τ_{N}. These cyclical delays provide “echoes” within the channel response, which increases the channel's frequency selectivity.

FIG. 4 illustrates a particular example of cyclic delay that may be introduced into a symbol according to one embodiment of the invention. As described above, cyclic delay may be introduced into a symbol or data constellation modulated on an OFDM carrier signal. A symbol 410, within the time domain, is shown without any cyclic delay or prefix introduced. This symbol represents a symbol that may be transmitted from the first data path 340 illustrated in FIG. 3. A second version of the symbol 410 is shown with a cyclic prefix or delay of length τ₂ in which a particular number of samples (corresponding to length τ₂) are shifted resulting in a cyclic prefix 430 attached to the end of the second version of the symbol 410. A guard interval 450 may be inserted at the end of the cyclic prefix 430. This second version of the symbol 410 and corresponding cyclic prefix 430 may be representative of a symbol transmitted on the second data path 350 in FIG. 3.

A third version of the symbol 410 is shown with a cyclic prefix 460 of length τ_{N} (the longest cyclic delay on the symbol 410). This third version of the symbol 410 and corresponding cyclic prefix 460 may be representative of a symbol transmitted on the nth data path 360 in FIG. 3. One skilled in the art will recognize that various cyclic delay progressions may be used to spread cyclic delay across multiple OFDM transmit data paths. In order to avoid adversely affecting the performance of the OFDM system, the guard interval length must be larger than the sum of the longest cyclic delay τ_{N} and the channel delay.

B. Maximum Cyclic Prefix Length Identification

FIG. 5 is a block diagram of a maximum cyclic prefix length identifier according to one embodiment of the invention. An appropriate cyclic prefix length is identified based on an analysis of channel frequency correlations, coherence bandwidth, and RMS delay. This analysis may be performed at an OFDM transmitter or receiver.

As described above, an OFDM signal is received, which is in the time domain. Using a Fourier Transform 515, the OFDM signal is converted into the frequency domain. In this particular example, the analysis of the signal's frequency correlation is less resource intensive when performed in the frequency domain as compared to the time domain. Various types of components, well known in the art, may be used to transform the signal from the time domain to the frequency domain.

A frequency covariance module 520 calculates a frequency covariance function of the incoming OFDM signal. The OFDM signal may be represented in the frequency domain as:

$$Y = {\sum }_{n = 1}^{N} {X}_{n}$$

where N is the number of frequency tones and X is the narrowband signals in the OFDM signal. This OFDM signal in the frequency domain may be graphically represented by the exemplary subcarrier index plot illustrated in FIG. 6A. In this illustration, a plurality of frequencies is shown, each having a particular amplitude. Each of these frequencies operates as a carrier within the OFDM channel and is modulated to contain data. Various modulation techniques may be performed such as quadrature amplitude modulation (“QAM”) or binary phase shift keying (“BPSK”).

The correlation between each of these frequencies may be used to identify particular characteristics of the OFDM channel and a corresponding relationship to a guard interval length and an appropriate cyclic delay used therein. In particular, the frequency covariance module 520 calculates a covariance function according to:

$$C ( m ) = \frac{1}{N - m} {\sum }_{n = 1}^{N - m} {X}_{n} {X}_{n + m}$$

where C(m) statistically measures a relationship between two frequencies within the OFDM channel. This covariance function may be used to define a correlation function for the OFDM channel according to:

$$R ( m ) = \vert \frac{C ( m )}{C ( 0 )} \vert$$

where R(m) is a statistical measure of the frequency relationships bounded between the range of 1 and 0.

FIG. 6B illustrates an exemplary frequency covariance function graph according to one embodiment of the invention. The frequency covariance function provides discrete covariance values for integer N values. In one embodiment of the invention, this frequency covariance is bounded between 1 and 0 where 1 means a perfect correlation and 0 means no correlation. One skilled in the art will recognize that various frequency correlation functions and graphs may be generated from the covariance function; all of which are intended to fall within the scope of the present invention.

The frequency covariance module 520 applies a threshold value 640 to the frequency correlation function in order to identify an appropriate coherence bandwidth 650. The coherence bandwidth describes a range of frequencies in which the OFDM channel passes its spectral components with equal gain and linear phase.

In one embodiment of the invention, the threshold value 640 may be defined as 0.9 and is applied to the correlation function R(m). In this embodiment, the value of M is found and defined as the range of frequencies over which the frequency correlation is greater to or equal to 0.9 according to the frequency correlation function R(m). For example, if 0.9 is applied, then a particular R(m) value, such as a value of 32, is identified. From 802.11a, the total bandwidth may be defined as 20 MHz and the largest M value may be defined as 64. Using this information, the coherence bandwidth (Bc) may be defined as:

(32/64)×20 MHz=10 MHz

In such a scenario, the coherence bandwidth of 10 MHz would relate to 90% or greater frequency correlation. One skilled in the art will recognize that the applied threshold may range from 0 to 1 if a normalized correlation function is used or may be over any range depending on the characteristics of the particular correlation function.

An RMS delay calculation module 530 calculates an RMS delay associated with the identified coherence bandwidth. This calculation effectively converts subsequent signal processing from the frequency domain into the time domain. RMS delay is derived from the OFDM channel impulse response and represents the amplitude and time delay of a multi-path signals. An RMS delay (D_{R}) is inversely proportional to a signal's coherence bandwidth such that:

D_{R}=X/B_{C}

where B_{C} is the coherence bandwidth, is the signal's corresponding RMS delay and X is a scaling factor.

Using this relationship, the RMS delay calculation module 530 is able to derive RMS delay for an OFDM channel from its previously selected coherence bandwidth. In particular, a statistical relationship (including the scaling factor X) may be used to estimate the RMS delay from the calculated coherence bandwidth. For example, in the above-described example wherein a 10 MHz coherence bandwidth is calculated, X is equal to 5 resulting in an estimation of 0.5 μs for the corresponding RMS delay. One skilled in the art will recognize that various methods may be used to relate coherence bandwidth to RMS delay, all of which are intended to fall within the scope of the present invention. One such description of the relationship between RMS delay and coherence bandwidth is provided in “Mobile Radio Communications” Steele, R., IEEE Press (1994).

A cyclic prefix length selector 540 selects a maximum cyclic delay (C_{MAX}) or cyclic prefix length according to an inversely proportional relationship with RMS delay. In one embodiment of the invention, a maximum cyclic delay is selected according to:

C_{MAX}=A*(1/D_{R}), where A is a scaling factor

In another embodiment of the invention, the maximum cyclic delay may be calculated according to:

C_{MAX}=B−D_{R}, where B is a constant

The scaling factor, A, and the constant, B, may be determined using various methods including through simulation.

In one embodiment, the identification of a maximum cyclic delay length and the selection of a cyclic prefix may be performed at a receiver and provided to a transmitter. In another embodiment, the transmitter may assume channel reciprocity in a time division duplex (“TDD”) system and select the cyclic prefix accordingly.

C. Method of Selecting a Guard Interval Length

FIG. 7 illustrates a method for selecting an appropriate cyclic prefix, independent of structure, for insertion into an OFDM symbol according to one embodiment of the invention. A wireless device receives 710 an OFDM signal and transforms 720 the signal into the frequency domain. One method in which the transformation may be performed is by applying a Fourier Transform on the signal.

A coherence bandwidth is determined 730 for the OFDM signal. In one embodiment, the coherence bandwidth may be determined using frequency correlation characteristics within the OFDM signal. A RMS delay 740 is estimated using the determined coherence bandwidth, which effectively converts the signal processing thereafter into the time domain. The RMS delay is inversely proportional to the coherence bandwidth and may be statistically estimated therefrom. A scaling factor may be necessary in this estimation.

A maximum cyclic delay is approximated 750 according to an inversely proportional relationship with RMS delay. This maximum cyclic delay approximation may include the application of a scaling factor or constant. A cyclic prefix is selected that has a length equal to or less than the approximated maximum cyclic delay. This cyclic prefix is inserted 760 at an OFDM symbol or constellation prior to transmission.

While the present invention has been described with reference to certain embodiments, those skilled in the art will recognize that various modifications may be provided. Variations upon and modifications to the embodiments are provided for by the present invention, which is limited only by the following claims.

1. An apparatus for introducing cyclic delay to an OFDM symbol, the apparatus comprising:
a frequency correlation module, coupled to receive an OFDM signal in the frequency domain, that identifies a coherence bandwidth of the signal;
a RMS delay calculation module, coupled to communicate with the frequency correlation module, that determines an RMS delay associated with the coherence bandwidth of the signal; and
a cyclic prefix length selector, coupled to communicate with the RMS delay calculation module, that identifies a maximum cyclic delay based on an inverse relationship with the RMS delay.

2. The apparatus of claim 1 wherein the signal is converted into the frequency domain using a Fourier Transform.

3. The apparatus of claim 1 wherein the frequency correlation module uses a covariance function in order to identify a relationship between channel subcarrier frequencies and corresponding amplitudes.

4. The apparatus of claim 3 wherein the frequency correlation module identifies the coherence bandwidth by applying a threshold between 1 and 0 to the covariance function and wherein the coherence bandwidth is selected at 0.9 and defines a set of frequencies within the bandwidth.

5. The apparatus of claim 4 wherein the RMS delay calculation module identifies an RMS delay associated with the identified coherence bandwidth.

6. The apparatus of claim 5 wherein the RMS delay and the identified coherence bandwidth are inversely proportional to each other and related by a first scaling factor.

7. The apparatus of claim 1 wherein the maximum cyclic delay and the RMS delay are inversely proportional to each other and related by a second scaling factor.

8. The apparatus of claim 1 wherein maximum cyclic delay and the RMS delay are related to each other by a constant.

9. The apparatus of claim 8 wherein the constant is identified by simulating the performance of OFDM symbol.

10. The apparatus of claim 1 wherein the cyclic prefix length selector selects a cyclic prefix having a length smaller than the maximum cyclic delay.

11. A method for introducing cyclic delay to a symbol within an OFDM channel, the method comprising:
receiving a multi-path signal;
transforming the multi-path signal from a time domain to a frequency domain;
determining a coherence bandwidth for the multi-path signal using correlation between frequencies within the signal;
calculating an RMS delay within the time domain using the determined coherence bandwidth; and
introducing cyclic delay within the multi-path communication channel according to an inversely proportional relationship with the RMS delay.

12. The method of claim 11 further comprising the step of calculating a covariance function for the multi-path signal that describes the frequencies and corresponding amplitude therein.

13. The method of claim 12 wherein the covariance bandwidth is determined by applying a 90 percent threshold to a frequency correlation function derived from the covariance function.

14. The method of claim 13 wherein the RMS delay is inversely proportional to the covariance bandwidth and related by a scaling factor of 5.

15. The method of claim 11 wherein the cyclic delay is inversely proportional to the RMS delay by a scaling factor.

16. The method of claim 11 wherein the cyclic delay is related to the RMS delay by a constant.

17. The method of claim 11 further comprising the step of introducing a cyclic prefix into a data symbol in which the cyclic prefix length is smaller than the maximum cyclic delay.

18. A computer program product embodied on a computer readable medium for selecting a length of a guard interval, the computer program product comprising computer instructions for:
receiving a multi-path signal;
transforming the multi-path signal from a time domain to a frequency domain;
determining a coherence bandwidth for the multi-path signal using correlation between frequencies within the signal;
calculating an RMS delay within the time domain using the determined coherence bandwidth; and
introducing cyclic delay within the multi-path communication channel according to an inversely proportional relationship between cyclic delay and RMS delay.

19. The computer program product of claim 18 wherein the cyclic delay is introduced at an OFDM symbol using a cyclic prefix having a length greater than or equal to a maximum cyclic delay.

20. The computer program product of claim 19 wherein the cyclic delay and RMS delay are inversely related by a scaling factor.
